(19) United States
(12) Patent Application Publication
(10) Pub. No.: US 2008/0121347 A1
(43) Pub. Date: May 29, 2008

(54) Wafer protection tape cutting apparatus, back lapping equipment, and wafer protection tape cutting method using the same

(75) Inventor: In-Su Kim, Yongin-si (KR)

Correspondence Address: MILLS & ONELLO LLP, ELEVEN BEACON STREET, SUITE 605, BOSTON, MA, 02108, US

(73) Assignee: Samsung Electronics, Co., Ltd., Suwon-si (KR)

(21) Appl. No.: 11/998,028

(22) Filed: Nov. 28, 2007

(30) Foreign Application Priority Data
Nov. 28, 2006 (KR) 10-2006-0118375

(51) Int. Cl. B32B 38/10

(52) U.S. Cl. 156/510

(57) ABSTRACT

A wafer protection tape cutting apparatus comprises: a chuck on which a wafer is held, the chuck being rotatable at a predetermined speed and being movable up and down; a protection tape supply unit for supplying a protection tape to be attached onto a top side of the wafer and to cover an upper part of the chuck; a light irradiation unit for irradiating light to harden a bonding agent of the protection tape, along an outer circumference part of the wafer; and a tape cutting unit for cutting the protection tape positioned at the outer circumference part of the wafer. The present invention also provides back lapping equipment having the wafer protection tape, and a wafer protection tape cutting method using the wafer protection tape cutting apparatus.

### CROSS-REFERENCE TO RELATED APPLICATION

This application claims priority from Korean Patent Application No. 10-2006-0118375, filed Nov. 28, 2006, the contents of which are hereby incorporated herein by reference in their entirety as if set forth fully herein.

### BACKGROUND OF INVENTION

1. Technical Field

The present invention relates to back lapping equipment, and more particularly, to a wafer protection tape cutting apparatus which is capable of cutting a protection tape attached to a front side of a wafer, along an outer edge of the wafer, without generating particles, back lapping equipment, and a wafer protection tape cutting method using the same.

2. Discussion of the Related Art

As yield of production of wafer dies has increased, productivity is improved and manufacturing cost is reduced, thereby accelerating the need for semiconductor packages to be light and small. To satisfy this need, wafers need to be large in diameter and thin in thickness.

A process of polishing a back side of a wafer is one of the techniques for realizing a thinner wafer. The “back side” of a wafer is the side of the wafer opposite to a top side of the wafer on which an integrated circuit is formed. After a wafer fabrication process is completed, the back side of a wafer is polished to a thickness that does not affect the integrated circuit, thereby reducing the thickness of the wafer.

The process of polishing a back side of a wafer is performed after an electric die sorting (EDS) generally performed on a wafer is completed. A conventional process of polishing a back side of a wafer will be described.

To protect an integrated circuit formed on the top side of the wafer during the polishing process, a protection tape is attached onto an active surface of the wafer on which the integrated circuit is formed.

The protection tape is cut along an outer edge of the wafer. Accordingly, the protection tape has the same size as that of the active surface of the wafer and is attached onto the active surface of the wafer.

Subsequently, as illustrated in FIGS. 1 and 2, the back side of the wafer onto which the protection tape being cut in the aforementioned manner is attached is polished to a predetermined thickness by a polishing device 500. When the polishing process is completed, the protection tape attached onto the active surface of the wafer W is removed from the active surface of the wafer.

During the above described process, the protection tape cut along the outer edge of the wafer W is generally cut using a cutter with a blade.

Accordingly, the protection tape is cut by direct contact with an end of the blade. Then, a bonding agent is applied to a bottom surface of the protection tape to be attached onto the active surface of the wafer. The bonding agent of the protection tape sticks to the end of the blade when the protection tape is cut by the blade.

When the process of cutting the protection tape by the blade is repeatedly performed, particles due to the bonding agent sticking to the blade remain on the active surface of the wafer W or the surface of the protection tape (see ‘P’ in FIGS. 1 and 2).

The wafer W is held in a wafer chuck 540 such that the back side of the wafer W is exposed upwardly. The back side of the wafer W is polished, by physical contact with a polishing unit 510 positioned above the wafer W.

The particles P remaining between the active surface of the wafer W and the protection tape cause a step. When a portion including the step physically contacts with the polishing unit 510 and is pressed or excessively polished, a crack occurs on the active surface of the wafer W or the wafer W is broken.

Due to the aforementioned problem, in the conventional process of polishing a back side of a wafer, the blade needs to be periodically replaced with a new blade, based on the number of times the cutting has been performed. However, even though the blade is periodically replaced, since it is difficult to quantitatively determine an amount of the particles generated by the bonding agent sticking to the blade, there is the problem in that the crack or breakage of the wafer cannot be completely eliminated.

### SUMMARY OF THE INVENTION

Therefore, the present invention is directed to provide a wafer protection tape cutting apparatus which prevents additional particles from being generated on a wafer or a protection tape due to a bonding agent included in the protection tape, when cutting the protection tape attached onto an active surface of the wafer so as to correspond to the active surface, and a wafer protection tape cutting method using the same apparatus.

The present invention also provides a wafer protection tape cutting apparatus which prevents a crack or breakage from occurring on a wafer including an active surface onto which a protection tape is attached, so that a back side of the wafer is stably polished, and a wafer protection tape cutting method using the same apparatus.

The present invention also provides a wafer protection tape cutting apparatus which is not affected by a period of replacing a cutting unit even if a process of cutting a protection tape attached onto an active surface of a wafer so as to correspond to the active surface is repeated several times, so that the productivity of the product is improved and the product has good quality, and a wafer protection cutting method using the same apparatus.

According to one aspect, the present invention is directed to a wafer protection tape cutting apparatus, which includes a chuck on which a wafer is held, the chuck being rotatable at a predetermined speed and being movable up and down. A protection tape supply unit supplies a protection tape to be attached onto a top side of the wafer and to cover an upper part of the chuck. A light irradiation unit irradiates light to harden a bonding agent of the protection tape, along an outer circumference part of the wafer. A tape cutting unit for cuts the protection tape positioned at the outer circumference part of the wafer.

The chuck may comprise a light guide hole formed, at a predetermined depth, downward adjacent to the outer circumference part of the wafer being held.

The tape cutting unit may comprise: a knife and a lift unit connected to the knife, wherein, as the lift unit operates, the knife cuts the protection tape while one end of the knife is inserted adjacent to the light guide hole.

The tape cutting unit may comprise: a rotation motor positioned above a middle position of the chuck; a knife positioned above the light guide hole; and a connection rod connecting the knife and the rotation motor. As the chuck is moved up and down, the knife cuts the protection tape while one end of the knife is inserted adjacent to the light guide hole.

The light irradiation unit may comprise: a light source for generating the light; a light controller for controlling the intensity of irradiation of the light; a light emitter for emitting the light with the intensity of irradiation being controlled; and a shutter for opening and closing an irradiation path of the light being emitted. As the chuck is rotated, the shutter is opened to form the irradiation path of the light.

In one embodiment, the light has a light irradiation area with a predetermined width from an outer circumference surface of the wafer.

In one embodiment, the light is UV light, and the UV light has an intensity of illumination of 350 mW/cm² and an intensity of radiation of 1000 mJ/cm².

The knife may be positioned to be tilted at a predetermined angle to a perpendicular side based on the top side of the wafer, according to a shape of the outer circumference part of the wafer.

The light irradiation may be performed simultaneously with cutting the protection tape.

In one embodiment, the light irradiation unit is positioned under the light guide hole, a light transparent area is positioned directly under the light guide hole formed in the chuck and is composed of a light transparent material, and the light irradiation unit positioned under the chuck irradiates the UV light transmitting the light transparent area onto the protection tape.

In another aspect, the present invention is directed to back lapping equipment. The back lapping equipment includes: a cutting device for cutting the protection tape attached onto a top side of the wafer, along a shape of the wafer; a polishing device for polishing a back side of the wafer after cutting the protection tape; and a pilling device for removing the protection tape being cut from the top side of the wafer after polishing the back side.

The back lapping equipment may further include a loading device for loading a wafer onto a chuck where the protection tape is to be cut.

The cutting device may comprise: a chuck on which the wafer is held, the chuck including a light guide hole formed at a predetermined depth downward adjacent to the outer circumference part of the wafer being held, and the chuck being rotatable at a predetermined speed and being movable up and down; a protection tape supply unit for supplying the protection tape to be attached onto the top side of the wafer and to cover an upper part of the chuck; a light irradiation unit for irradiating light to harden a bonding agent of the protection tape, along an outer circumference part of the wafer; and a tape cutting unit for cutting the protection tape positioned at the outer circumference part of the wafer.

The tape cutting unit may comprise: a knife and a lift unit connected to the knife, wherein, as the lift unit operates, the knife cuts the protection tape while one end of the knife is inserted adjacent to the light guide hole.

The light irradiation unit may comprise: a light source for generating the light; a light controller for controlling the intensity of irradiation of the light; a light emitter for emitting the light with the intensity of irradiation being controlled; and a shutter for opening and closing an irradiation path of the light being emitted. As the chuck is rotated, the shutter is opened to form the irradiation path of the light.

In one embodiment, the light is UV light. The UV light may be irradiated having an intensity of illumination of 350 mW/cm² and with an intensity of radiation of 1000 mJ/cm².

The knife may be positioned to be tilted at a predetermined angle to a perpendicular side based on the top side of the wafer, according to a shape of the outer circumference part of the wafer.

The light irradiation may be performed simultaneously with cutting the protection tape.

A light transparent area may be positioned directly under the light guide hole formed in the chuck and may be composed of a light transparent material, and the light irradiation unit positioned under the chuck may irradiate the UV light transmitting the light transparent area onto the protection tape.

In another aspect, the present invention is directed to a wafer protection tape cutting method. The method comprises: holding a wafer on a chuck being rotatable at a predetermined speed; attaching a protection tape on the chuck including a top side of the wafer; irradiating UV light onto a light irradiation area formed from an outer circumference surface of the wafer; and cutting the protection tape along the light irradiation area.

In one embodiment, when the chuck is rotated, the UV light is irradiated onto the light irradiation area.

The UV light may have an intensity of illumination of 350 mW/cm² and an intensity of radiation of 1000 mJ/cm².

The irradiating of the light and the cutting of the protection tape may be performed simultaneously.

### BRIEF DESCRIPTION OF THE DRAWINGS

The foregoing and other objects, features and advantages of the invention will be apparent from the more particular description of preferred aspects of the invention, as illustrated in the accompanying drawings in which like reference characters refer to the same parts throughout the different views. The drawings are not necessarily to scale, emphasis instead being placed upon illustrating the principles of the invention.

FIG. 1 is a sectional view illustrating a back side of a wafer to be polished.

FIG. 2 is an enlarged sectional view of mark A indicated in FIG. 1.

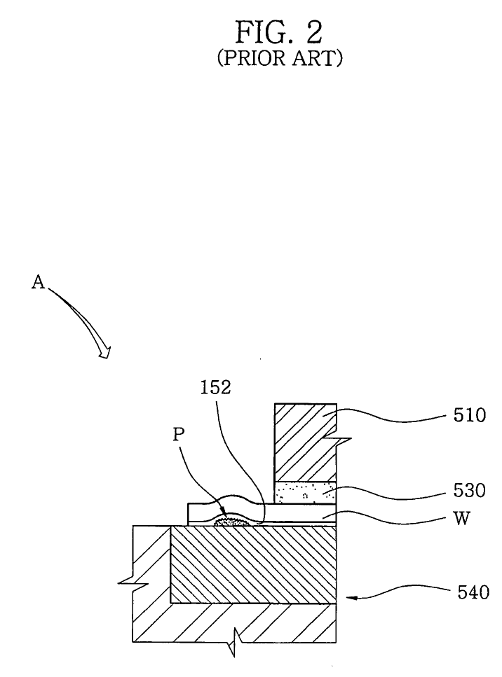

FIG. 3 is a sectional view illustrating a wafer protection tape cutting apparatus according to an embodiment of the present invention.

FIG. 4 is a plan view illustrating a protection tape taped on a top side of the wafer of FIG. 3.

FIG. 5 is a sectional view illustrating a wafer protection tape cutting apparatus according to another embodiment of the present invention.

FIG. 6 is a sectional view illustrating a wafer protection tape cutting apparatus according to another embodiment of the present invention.

FIG. 7 is a flow chart illustrating a wafer protection tape cutting method, using the wafer protection tape cutting apparatus of the present invention.

### DETAILED DESCRIPTION OF PREFERRED EMBODIMENTS OF THE INVENTION

A wafer protection tape cutting apparatus, back lapping equipment, and a wafer protection tape cutting method using the same according to the present invention will now be described more fully hereinafter with reference to the accompanying drawings, in which preferred embodiments of the invention are shown.

A wafer protection tape cutting apparatus according to the present invention will be first described.

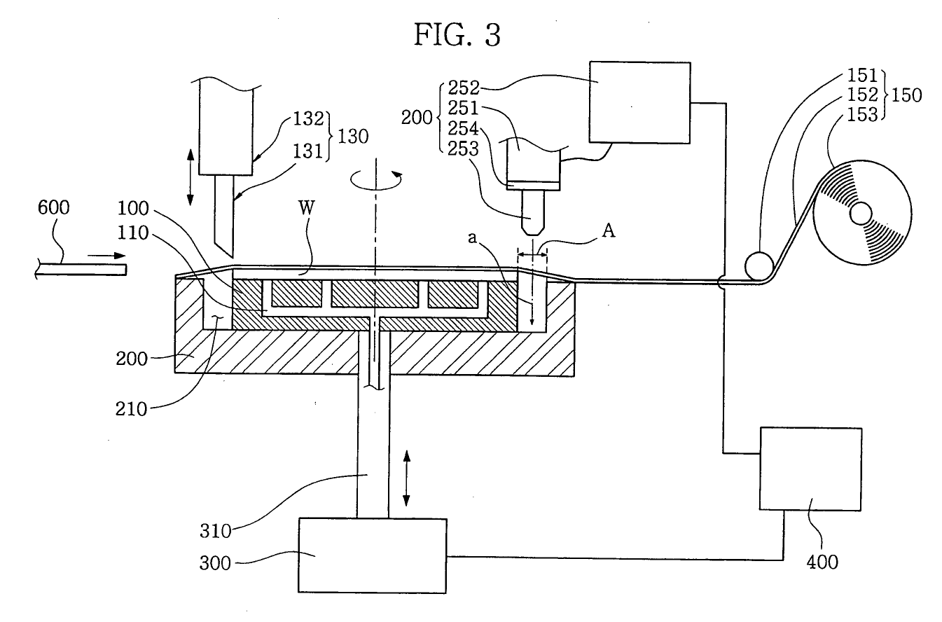

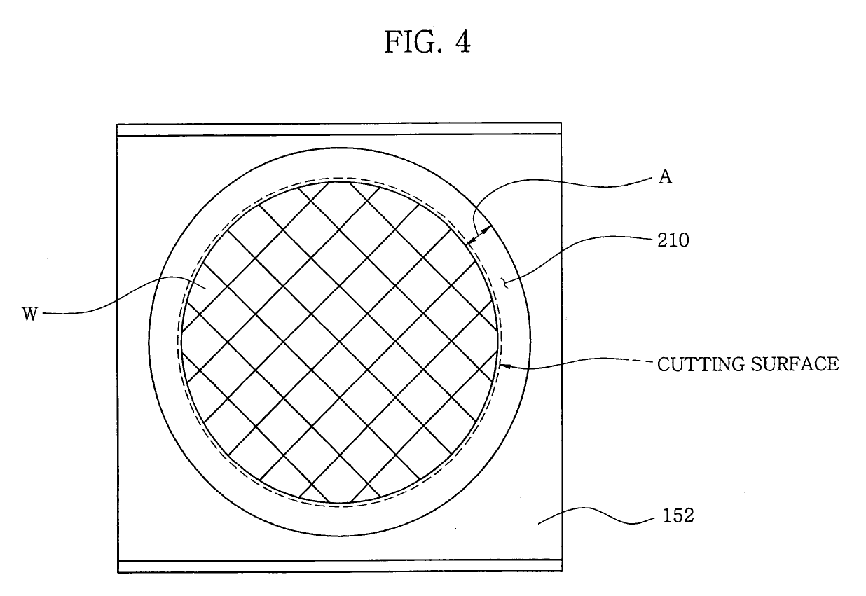

FIG. 3 is a sectional view illustrating a wafer protection tape cutting apparatus according to an embodiment of the present invention. FIG. 4 is a plan view illustrating protection tape on a top side of the wafer of FIG. 3.

Referring to FIGS. 3 and 4, the wafer protection tape cutting apparatus includes a chuck 100. A wafer W is held on the chuck 100. A vacuum hole 110 is formed in the chuck 100 and provides a bottom surface of the wafer W with a vacuum adsorption force. The vacuum hole 110 is connected to a vacuum supply unit (not shown) and receives the vacuum adsorption force from the vacuum supply unit.

A rotation shaft 310 is connected to a bottom part of the chuck 100. The rotation shaft 310 is connected to a rotation motor 300. Accordingly, a rotation force provided from the rotation motor 300 is transferred to the rotation shaft 310, so that the chuck 100 connected to the rotation shaft 310 is rotated at a predetermined speed.

A guide 200 is provided to cover an outer circumference part and a bottom part of the chuck 100. The guide 200 covers the outer circumference part of the chuck 100, spaced apart from the outer circumference part of the chuck 100 at a predetermined interval. Accordingly, a light guide hole 210 having a width which corresponds to the spaced interval is formed in the guide 200.

A protection tape supply unit 150 is positioned apart from the chuck 100 at a predetermined distance. The protection tape supply unit 150 includes a protection tape 152, a reel 153, and a guide ball 151. The protection tape 152 winds around the reel 153 at the predetermined number of times of winding. The guide ball 151 provides a direction in which the protection tape 152 is supplied from the reel 153 and provides the protection tape 152 with predetermined elasticity and tension. A bonding agent is applied to a bottom surface of the protection tape 152.

The protection tape 152 supplied from the reel 153 is supplied to an upper part of the wafer W held in the chuck 100. The bottom surface of the protection tape 152 being supplied covers a top side of the wafer W, that is, an active surface of the wafer W on which semiconductor chips and integrated circuits are formed, above the chuck 100. The top side of the wafer W is secured against and bonded with the bottom surface of the protection tape 152.

A light irradiation unit 200 is positioned above the chuck 100. The light irradiation unit 200 includes a light source 251, a light controller 252, a light emitter 253 and a shutter 254. The light source 251 generates light, such as UV light. The light controller 252 controls the intensity of radiation of the light generated by 15 the light source 251. The light emitter 253 emits the light controlled by the light controller 252. The shutter 254 opens or closes a light irradiation path (a) of the light being emitted in one particular embodiment, the UV light has an intensity of illumination of 350 mW/cm² and an intensity of radiation of 1000 mJ/cm². The extent and time of hardening of the bonding agent applied to the bottom surface of the protection tape 152 is proportional to the intensity of illumination and the intensity of radiation of the UV light.

Specifically, the light emitter 253 is positioned above the light guide hole 210. Accordingly, the UV light irradiated from the light emitter 253 forms the light irradiation path (a) toward the light guide hole 210.

A light irradiation area (A) of the UV light irradiated from the light emitter 253 may cover the width of the light guide hole 210.

The shutter 254 may be operated as the rotation motor 300 rotates. A control unit 400 sends a driving signal to the rotation motor 300. The control unit 400 sends an opening signal to the shutter 254. Accordingly, when the rotation motor 300 is operated and the chuck 100 is rotated, the shutter 254 is opened to form the light irradiation path (a).

The protection tape 152 supplied on the top side of the wafer W above the chuck 100 is exposed, at the light irradiation area (A), to the UV light irradiated toward the light guide hole 210. The light irradiation area (A) may include the width of the light guide hole 210. The bonding agent of the protection tape 152, which is exposed to the UV light in the portion corresponding to the light irradiation area (A), is hardened.

A tape cutting unit 130 is provided to cut the protection tape 152 in which the bonding agent exposed to the UV light at the light irradiation area (A) is hardened. The tape cutting unit 130 cuts the protection tape 152, along an outer circumference part of the wafer W. Consequently, the protection tape 152 is cut to correspond to a shape of the wafer W.

The tape cutting unit is positioned above the light guide hole 210. That is, as illustrated in FIG. 3, the tape cutting unit and the light irradiation unit 200 are positioned above the light guide hole 210, to be in opposite sides.

The tape cutting unit includes a knife 131 and a lift unit 132 connected to the knife 131. As the lift unit 132 is operated to move down, one end of the knife 131 is moved down to be inserted in the light guide hole 210, thereby cutting the protection tape 152 at the portion where the bonding agent is hardened.

One side end of the knife 131 may be positioned to be tilted, at a predetermined angle, with respect to a perpendicular side to the top side of the wafer W, according to a shape of the outer circumference part of the wafer W.

Then, even though the light irradiation unit 200 and the tape cutting unit are fixed above the chuck 100, since the chuck 100 including the wafer W is rotated by the rotation motor 300, the light irradiation area (A) of the protection tape 152 may be exposed to the UV light or may be cut, along the outer circumference part of the wafer W.

Back lapping equipment according to the present invention may include the wafer protection tape cutting apparatus constituted as described above.

More specifically, referring to FIG. 3, the back lapping equipment includes a cutting device, a polishing device 500, and a pilling device 600. The cutting device cuts the protection tape 152 attached to a top side of a wafer W, along the shape of the wafer W. The polishing device 500 polishes a back side of the wafer W in which the protection tape is cut. The pilling device 600 removes the protection tape 152 from the top side of the wafer W, the back side of which is polished.

The cutting device includes the chuck 100, the protection tape supply unit 150, the light irradiation unit 200, and the tape cutting unit 130. The chuck 100 holds the wafer W and includes the light guide hole 210 formed, at a predetermined depth, downward adjacent to outer circumference part of the wafer W being held. The chuck 100 is rotated at a predetermined speed and moved up and down. The protection tape supply unit 150 supplies the protection tape 152 which is bonded with the top side of the wafer W and covers an upper part of the chuck 100. The light irradiation unit 200 irradiates a UV light to harden the bonding agent applied to the protection tape 152, along the outer circumference part of the wafer W. The tape cutting unit 130 cuts the protection tape 152 positioned at the outer circumference part of the wafer W.

The pilling device 600 is spaced apart from the chuck 100, at a predetermined distance. After the back side of the wafer W is polished, the pilling device 600 adsorbs and removes the protection tape 152 attached onto the top side of the wafer W.

Since the tape cutting unit 130 has the same configuration described above, the description thereof will not be repeated.

The wafer protection tape cutting apparatus and the back lapping equipment according to the present invention, in the above-described configuration, will be described with respect to the operation and effects. In addition, a wafer protection tape cutting method according to the present invention will be described.

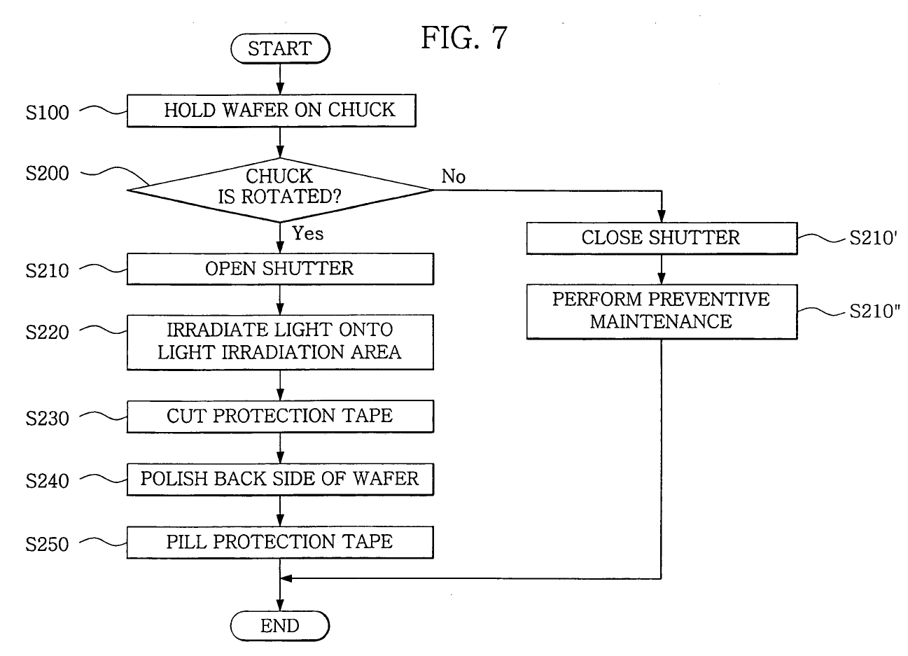

FIG. 7 is a flow chart illustrating the wafer protection tape cutting method.

Referring to FIGS. 3 and 7, a wafer W is held on the chuck 100 (S100). That is, the wafer W is vacuum-adsorbed and fixed onto the chuck 100. The wafer W is fixed by a vacuum adsorption force supplied through a vacuum hole 110 which is formed in the chuck 100. The chuck is rotated, at a predetermined speed, by a rotation force provided from a rotation motor 300.

A control unit 400 monitors whether the chuck 100 is rotated (S200). When the chuck 100 is rotated, the control unit 400 operates the light irradiation unit 200. However, when the chuck 100 is not rotated, the shutter 254 is not opened (S210′), maintenance is performed (S210″), and the end of the process is reached.

For example, the case where the chuck 100 is rotated and the shutter 254 is opened will be described.

The control unit 400 monitors whether the chuck 100 is rotated (S200). When the chuck 100 is rotated, the shutter 254 of the light irradiation unit 200 is opened by the control unit 400 (S210). When the shutter 254 is opened, the light irradiation path (a) is formed with respect to the UV light emitted from the light emitter 253. The light irradiation path (a) is formed at the light irradiation area (A) formed on the protection tape 152.

The protection tape 152, which is positioned on the light guide hole 210 formed in the space between the guide 200 and the chuck 100, is exposed to the UV light being irradiated (S220). Accordingly, the bonding agent applied to the bottom surface of the protection tape 152 exposed to the UV light is hardened. The tape cutting unit cuts the protection tape 152, along the light irradiation area (A) (S230).

Then, a lift unit 132 moves down a knife 131 toward the light guide hole 210. One side end of the knife 131 being moved down contacts with the protection tape 152 exposed to the UV light and is positioned inside the light guide hole 210. Accordingly, the protection tape 152 is in contact with the one side end of the knife 131 being moved down and is cut. The protection tape 152 is also cut, along the outer circumference part of the wafer W as the chuck 100 is rotated at a predetermined speed by the rotation force of the rotation motor 300.

The light irradiation area (A) of the protection tape 152 exposed to the UV light may be substantially the same as the width of the light guide hole 210 of the chuck 100. The bonding agent applied to the bottom surface of the protection tape 152 at the light irradiation area (A) where the UV light is irradiated is hardened. In this state, since the protection tape 152 with the bonding agent being hardened is cut by the knife 131, the bonding agent in a gel state does not stick to the one side end of the knife 131 and does not remain on the top side of the wafer W.

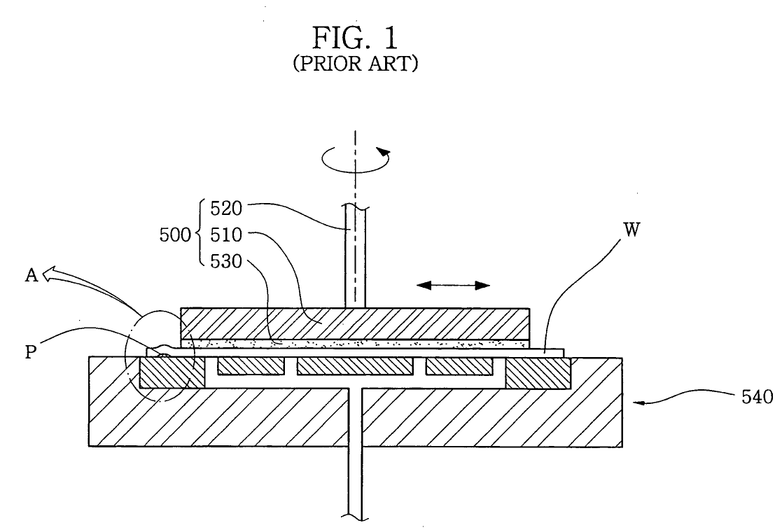

After the protection tape 152 is cut so as to correspond to the size of the top side of the wafer W, a back side of the wafer W may be polished, to a predetermined thickness, by a polishing device 500 as illustrated in FIG. 1 (S240). The polishing device 500 includes the rotation shaft 520, the polishing unit 510, and the polishing material 530. The rotation shaft 520 is rotated by power transferred from the outside. The polishing unit 510 has a disc shape and its middle portion is connected to one end of the rotation shaft 520. The polishing material 530 coats a bottom part of the polishing unit 510. A wafer chuck 540 is positioned under of the polishing unit 510 and vacuum-adsorbs the bottom surface of the wafer W. Accordingly, the back side of the wafer W directly contacts with the polishing material 530 and is polished while the polishing unit 510 is rotated at a predetermined speed.

After the back side of the wafer W is polished, the protection tape 152 attached onto the top side of the wafer W may be pilled (S250).

In the present invention, when the protection tape 152 is cut, along the outer circumference part of the wafer W, the protection tape 152 positioned at the outer circumference part of the wafer W is exposed to the UV light, so that the bonding agent applied to the bottom surface of the protection tape 152 is hardened in advance. Accordingly, when the protection tape 152 positioned at the outer circumference part of the wafer W is cut by the knife 131, particles due to the bonding agent do not stick to the one side end of the knife 131 or do not remain on the top side of the wafer W. Consequently, when the back side of the wafer W is polished, it is possible to prevent a crack or breakage of the wafer due to the particles.

While the chuck 100 is rotated by the control unit 400, the protection tape 152 is cut, as described above. However, according to the present invention, the protection tape 152 can be cut while simultaneously rotating the chuck 100. Since the operation of the tape cutting unit which cuts the protection tape 152 is the same as that described above, description thereof will not be repeated.

As an example of the wafer protection tape cutting apparatus as described above, the protection tape 152 is cut as the chuck 100 is rotated.

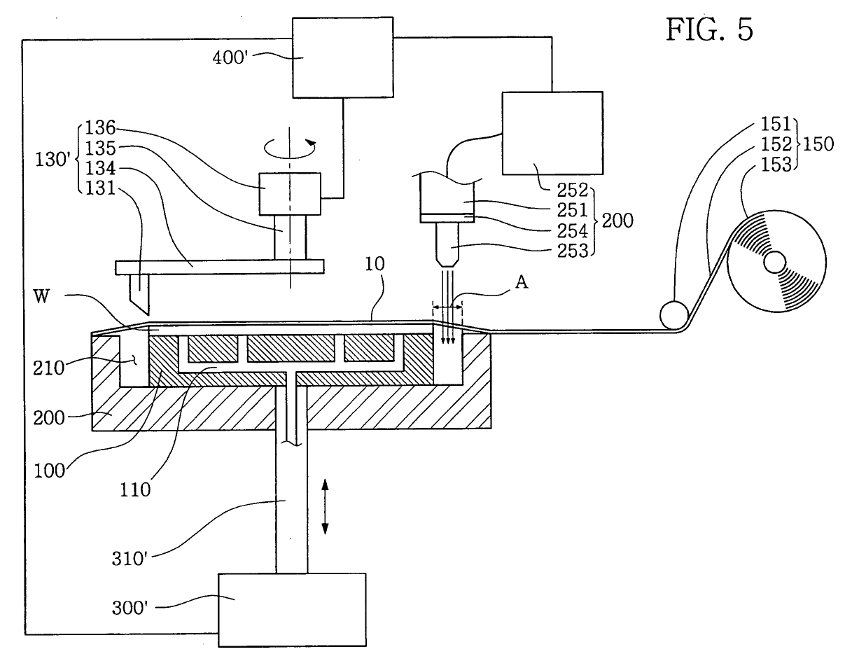

However, as illustrated in FIG. 5, in a wafer protection tape cutting apparatus according to another embodiment of the present invention, the protection tape 152 is cut by rotating a tape cutting unit 130′, without rotating the chuck 100.

That is, the tape cutting unit 130′ includes a knife 131 and may further include another rotation motor 136 positioned in the middle portion above the chuck 100, a rotation shaft 135 of the rotation motor 136, and a connection rod 134 connecting the rotation shaft 135 and one end of the knife 131.

A middle portion of the lower part of the chuck 100 is connected to another lift unit 300′.

The operation of the wafer protection tape cutting apparatus according to the embodiment of the present invention in FIG. 5 will be described. When the light is irradiated onto a light irradiation area (A) of the protection tape 152, the control unit 400′ rotates the knife 131 above the chuck 100 using the rotation motor 136. Subsequently, the control unit 400′ moves up the chuck 100 at a predetermined height using the lift unit 300′.

Accordingly, the light irradiation area (A) of the protection tape 152 contacts with one side end of the knife 131, and the knife 131 cuts the protection tape 152, along an outer circumference part of the wafer W held on the chuck being rotated.

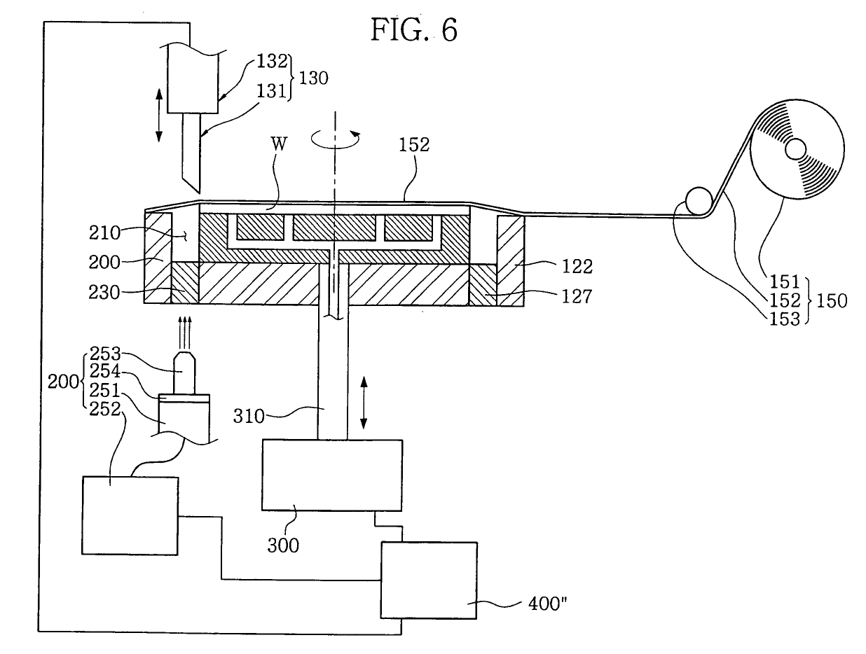

As illustrated in FIG. 6, in a wafer protection tape cutting apparatus according to another embodiment of the present invention, the light irradiation unit 200 may be positioned under the light guide hole 210 of the chuck 100.

When the light irradiation unit 200 is positioned under the light guide hole 210, a light transparent area 230 formed directly under the light guide hole 210 formed in the chuck 100 may be composed of a light transparent material, and the light irradiation unit 200 positioned under the chuck 100 may irradiate the UV light transmitting the light transparent area 230 onto the protection tape 152.

As described above, in accordance with the present invention, when cutting the protection tape attached onto the active surface formed on the top side of a wafer so as to correspond to the active surface, using the knife, the protection tape corresponding to a part to be cut is exposed to the UV light, so that the bonding agent applied to the bottom surface of the protection tape exposed to the light is hardened. Then, the protection tape is cut by the knife, so that the bonding agent applied to the protection tape does not stick to the knife or any additional particles are prevented from remaining between the wafer and the protection tape.

Furthermore, in accordance with the present invention, since the particles which are residues of the bonding agent are prevented from remaining on the top side of the wafer, when a back side of the wafer is polished, the wafer with the top side as the active surface onto which the protection tape is attached is prevented from being cracked or broken.

Furthermore, in accordance with the present invention, when the protection tape attached onto the active surface of the wafer is cut to correspond to the active surface, even though a cutting process is several times repeated, the wafer protection tape cutting apparatus is not affected by a period of replacing the knife as a cutting unit, thereby improving the productivity of the product and producing the product with good quality.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A wafer protection tape cutting apparatus, comprising:
a chuck on which a wafer is held, the chuck being rotatable at a predetermined speed and being movable up and down;
a protection tape supply unit for supplying a protection tape to be attached onto a top side of the wafer and to cover an upper part of the chuck;
a light irradiation unit for irradiating light to harden a bonding agent of the protection tape, along an outer circumference part of the wafer; and
a tape cutting unit for cutting the protection tape positioned at the outer circumference part of the wafer.

2. The apparatus of claim 1, wherein the chuck comprises a light guide hole formed, at a predetermined depth, downward adjacent to the outer circumference part of the wafer being held.

3. The apparatus of claim 2, wherein the tape cutting unit comprises:
a knife; and
a lift unit connected to the knife,
wherein, as the lift unit operates, the knife cuts the protection tape while one end of the knife is inserted adjacent to the light guide hole.

4. The apparatus of claim 2, wherein the tape cutting unit comprises:
a rotation motor positioned above a middle position of the chuck;
a knife positioned above the light guide hole; and
a connection rod connecting the knife and the rotation motor,
wherein, as the chuck is moved up and down, the knife cuts the protection tape while one end of the knife is inserted adjacent to the light guide hole.

5. The apparatus of claim 1, wherein the light irradiation unit comprises:
a light source for generating the light;
a light controller for controlling the intensity of irradiation of the light;
a light emitter for emitting the light with the intensity of irradiation being controlled; and
a shutter for opening and closing an irradiation path of the light being emitted,
wherein, as the chuck is rotated, the shutter is opened to form the irradiation path of the light.

6. The apparatus of claim 1, wherein the light has a light irradiation area with a predetermined width from an outer circumference surface of the wafer.

7. The apparatus of claim 1, wherein the light is UV light, and the UV light has an intensity of illumination of 350 mW/cm² and an intensity of radiation of 1000 mJ/cm².

8. The apparatus of claim 3 or claim 4, wherein the knife is positioned to be tilted at a predetermined angle to a perpendicular side based on the top side of the wafer, according to a shape of the outer circumference part of the wafer.

9. The apparatus of claim 1, wherein the light irradiation is performed simultaneously with cutting the protection tape.

10. The apparatus of claim 2, wherein the light irradiation unit is positioned under the light guide hole, a light transparent area is positioned directly under the light guide hole formed in the chuck and is composed of a light transparent material, and the light irradiation unit positioned under the chuck irradiates the UV light transmitting the light transparent area onto the protection tape.
